(19) United States
(12) Patent Application Publication
(10) Pub. No.: US 2006/0266701 A1
(43) Pub. Date: Nov. 30, 2006

(54) Gradient density depth filtration system

(76) Inventors: David P. Dickerson, Livingston, TN (US); Michael J. Monnin, Perrysburg, OH (US); Gary L. Rickle, Wharton, OH (US); Mark A. Borer, Ottawa, OH (US); James O. Stuart, Cookeville, TN (US); Yogeshwar K. Velu, Cookeville, TN (US); William C. Haberkamp, Cookeville, TN (US); Julie Anne Graber, Fostoria, OH (US)

Correspondence Address: KUNZLER & ASSOCIATES, 8 EAST BROADWAY, SUITE 600, SALT LAKE CITY, UT, 84111, US

(21) Appl. No.: 11/140,801

(22) Filed: May 31, 2005

(51) Int. Cl. B01D 39/00

(52) U.S. Cl. 210/503; 210/505; 210/490

(57) ABSTRACT

An apparatus, system and method to provide increasingly fine gradient density depth filtration of a fluid. The apparatus may include a melt-blown filtration assembly having varying densities of melt-blown microfilaments fabricated from acetal or other substantially dimensionally stable thermoplastic. The apparatus thus facilitates efficient filtration by providing a gradient density depth filtration system compatible with various fuels, coolants, and other forms of a fluid.

### BACKGROUND OF THE INVENTION

1. Field of the Invention

This invention relates to liquid filtration systems, and more particularly relates to a gradient density depth filtration system compatible with various fuels, coolants, and other liquid and gaseous fluids.

2. Description of the Related Art

The steadily increasing price of gasoline in recent years has led to increased use and availability of alternative fuels worldwide. Indeed, alternative fuels such as methanol, ethanol, natural gas, propane, biodiesel, electricity, hydrogen, and p-series fuels, are increasingly used as cost-effective, environmentally sound alternatives to gasoline. Such non-petroleum fuels are generally derived from domestically produced, renewable resources such as biological materials, solar energy, and coal. Natural gas is also abundantly used as a basic energy source for alternative fuels. Although not renewable, there is a plentiful supply of natural gas in both the United States and neighboring countries in North America. Alternative fuels thus provide a relatively secure form of energy, substantially immune from the mercurial costs and availability of gasoline, which depend on limited crude oil supplies abroad and finite refining capacity.

In use, alternative fuels are substantially clean burning compared to gasoline, yielding environmental benefits by reducing harmful pollutants and exhaust emissions. Further, alternative fuel vehicles generally consume less fuel than their standard vehicle counterparts. This too contributes to reduced vehicle emissions and associated environmental degradation.

While alternative fuel vehicles have been developed to benefit from the environmental and economic soundness of alternative fuels, such vehicles generally fail to realize the full potential of such fuels due to a fundamental chemical incompatibility between the fuels and the filters through which they are pumped. Indeed, most commercially available in-tank fuel filters are designed to filter gasoline or diesel fuel, and thus comprise materials suitable for such a purpose, without regard to the compatibility of such materials with alternative fuels. A typical fuel filter includes an outer layer that encapsulates an inner filtration media having one or more layers. Such a fuel filter, known as a depth media-type filter, generally exhibits high efficiency and capacity while effectively confining contaminants in the filter. To further optimize effective small particulate filtration, the inner filtration media of the depth media filter may comprise non-woven melt-blown thermoplastic filaments.

A web of melt-blown filaments provides fine filtration of a magnitude generally unattainable by conventional fabric weaving techniques. The melt blowing process subjects a thermoplastic filament strand to high velocity gas that attenuates the filament and breaks it down into microfibers. As the fibers move toward a collecting screen, the ambient air cools and solidifies the fibers into a self-bonded, non-woven web highly effective for small particle filtration.

The melt blowing process generally demands a thermoplastic polymer that is fluid enough to produce fine microfibers, while viscous enough to provide high fiber strength and prevent excessive fiber bonding or breakage. Similarly, it is important that the polymer adequately bond with other fibers upon solidifying, while avoiding coalescence by excess fusion. Indeed, untoward coalescence produces areas where the fibers lose their fibrous identity, and thus fail to function as a filter. For this reason, the more rapid the crystallization and the higher the melting point of the polymer, the better. The polymer generally deemed best suited for this demanding process, and that predominantly utilized in the fuel filter industry today, is nylon.

While melt-blown filaments of nylon perform well in conventional gasoline fuel filter systems, alternative fuels, particularly alcohol-containing fuels such as ethanol and methanol, tend to cause such filaments to swell, thus increasing the flow restriction to the fuel pump and reducing the flow of fuel to an engine. In addition, such filaments are susceptible to damage and degradation from exposure to various chemical components of alternative fuels. As a result, fuel efficiency and reliability in alternative fuel vehicles may be compromised.

Accordingly, a need exists for a gradient density depth media style filtration system that is compatible with alternative fuels. Beneficially, such a gradient density depth filtration system would maintain effective small particle filtration, resist chemically induced swelling and other chemically induced damage and effects, and optimize fuel efficiency and reliability in alternative fuel vehicles. Such a gradient density depth filtration system is disclosed and claimed herein.

### SUMMARY OF THE INVENTION

The present invention has been developed in response to the present state of the art, and in particular, in response to the problems and needs in the art that have not yet been fully solved by currently available gradient density depth media filtration systems. Accordingly, the present invention has been developed to provide a gradient density depth media filtration system that overcomes many or all of the above-discussed shortcomings in the art.

An apparatus to filter a fluid in accordance with certain embodiments of the present invention includes a melt-blown filtration assembly to provide increasingly fine filtration of a fluid, such as a coolant or fuel. The melt-blown filtration assembly may include varying densities of melt-blown microfilaments having a substantially constant diameter. In one embodiment, a diameter of the melt-blown microfilaments may range between about 2 and 5 μm. In some embodiments, the melt-blown microfilaments may be formed of a substantially dimensionally stable thermoplastic capable of resisting chemically induced effects. Examples of a substantially dimensionally stable thermoplastic include acetal, polyethylene, polyphenylenesulfide, high temperature nylon, or a combination thereof.

In certain embodiments, the melt-blown filtration assembly may include a single layer or multiple melt-blown layers, each melt-blown layer having a unique and substantially constant porosity of melt-blown microfilaments. The melt-blown layers may be arranged such that a porosity corresponding to each melt-blown layer decreases as a distance between the melt-blown layer and a target device decreases.

The apparatus may further include a general filtration element coupled to the melt-blown filtration assembly to provide coarse filtration, where the general filtration element comprises, for example, spun bonded filtration media. In certain embodiments, the apparatus may include an outer filtration element substantially adjacent the general filtration element to protect the general filtration and melt-blown filtration assembly against mechanical stresses.

A system of the present invention is also presented to provide gradient density depth filtration of a fluid. The system may be embodied by a tank adapted to store a fluid, a pump to pump the fluid to a target device, and a filter to filter the fluid prior to reaching the target device. The filter may include a melt-blown filtration assembly to provide increasingly fine filtration of the fluid, where the melt-blown filtration assembly includes varying porosities of melt-blown microfilaments having a substantially constant diameter. As in the apparatus, the melt-blown microfilaments may include a substantially dimensionally stable thermoplastic such as acetal, polyethylene, polyphenylenesulfide, high temperature nylon, or a combination thereof. The gradient filtration assembly may include an arrangement of melt-blown layers by porosity, each layer having a substantially constant porosity of melt-blown microfilaments unique to that layer, such that porosity decreases as a distance between the layer and a target device decreases. Finally, the filter may further include a general filtration element for coarse filtration, and an outer filtration element for protective purposes.

A method of the present invention is also presented for providing gradient density depth filtration of a fluid. In one embodiment, the method includes melt-blowing a substantially dimensionally stable thermoplastic to form melt-blown microfilaments having a substantially constant diameter, forming the melt-blown microfilaments into a melt-blown layer having a unique and substantially constant porosity, arranging a plurality of the melt-blown layers according to their relative porosities to produce a melt-blown filtration assembly, and filtering a fluid through the melt-blown filtration assembly to provide increasingly fine filtration of the fluid. In some embodiments, the method may further include selecting the substantially dimensionally stable thermoplastic to include at least one of acetal, polyethylene, polyphenylenesulfide, high temperature nylon, and substantially dimensionally stable thermoplastic. Further, filtering the fluid may include filtering a fluid selected from the group consisting of a coolant and a fuel.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a cross-sectional view of a fuel tank including a gradient density depth filtration system in accordance with certain embodiments of the present invention;

FIG. 2 is a cross-sectional view of one embodiment of a gradient density depth filtration system in accordance with the present invention;

FIG. 3 is a cross-sectional view of an alternate embodiment of a gradient density depth filtration system in accordance with the present invention;

FIG. 4 is a perspective view of a melt blowing apparatus that may be used to fabricate melt blown layers of the gradient density depth filtration system in accordance with certain embodiments of the present invention;

FIG. 5 is a magnified top view of melt-blown acetal microfilaments forming a first layer of a melt-blown filtration assembly in accordance with certain embodiments of the present invention;

FIG. 6 is a magnified top view of melt-blown acetal microfilaments forming a second layer of the melt-blown filtration assembly in accordance with certain embodiments of the present invention; and

FIG. 7 is a magnified top view of melt-blown acetal microfilaments forming a third layer of the melt-blown filtration assembly in accordance with certain embodiments of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used in this specification, the term “depth media” or “depth filter” refers to a staged or graduated arrangement of fibrous material that has the effect of increasing the surface area of the filter. The term “density gradient” refers to percent solids content of a particular depth media. The term “gradient density depth filtration” refers to a filtration process that uses depth media to provide an increasing density gradient (or decreasing porosity gradient) to filter and trap particles.

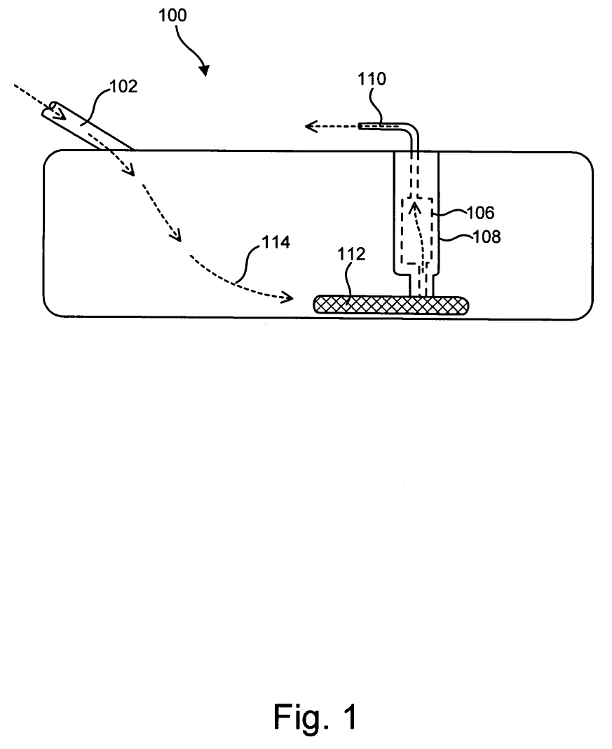

A gradient density depth filtration system in accordance with the present invention may be implemented to filter a fuel, a coolant, water, and/or any other fluid known to those in the art. FIG. 1 illustrates a conventional fuel system capable of implementing the gradient density depth filtration system of the present invention. The fuel system may include a fuel tank 100 having an inlet 102, a fuel sending unit 108, and a supply line 110. The fuel tank 100 may comprise metal, plastic, or other substantially rigid material known to those in the art capable of retaining and resisting the chemical effects of fuels such as gasoline, diesel fuel, alternative fuels such as methanol and ethanol, and/or any other fuel known to those in the art.

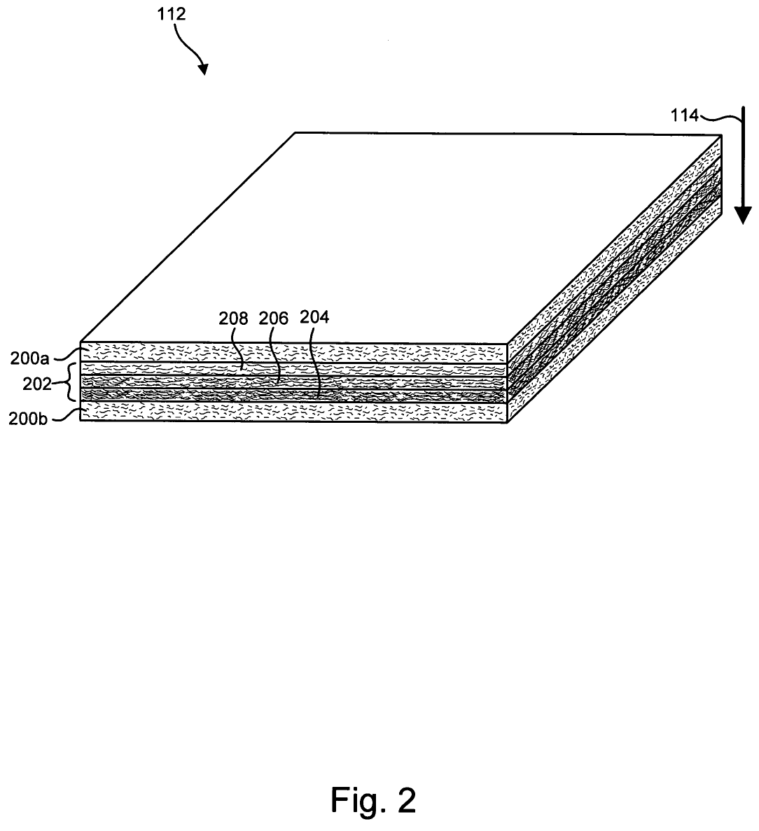

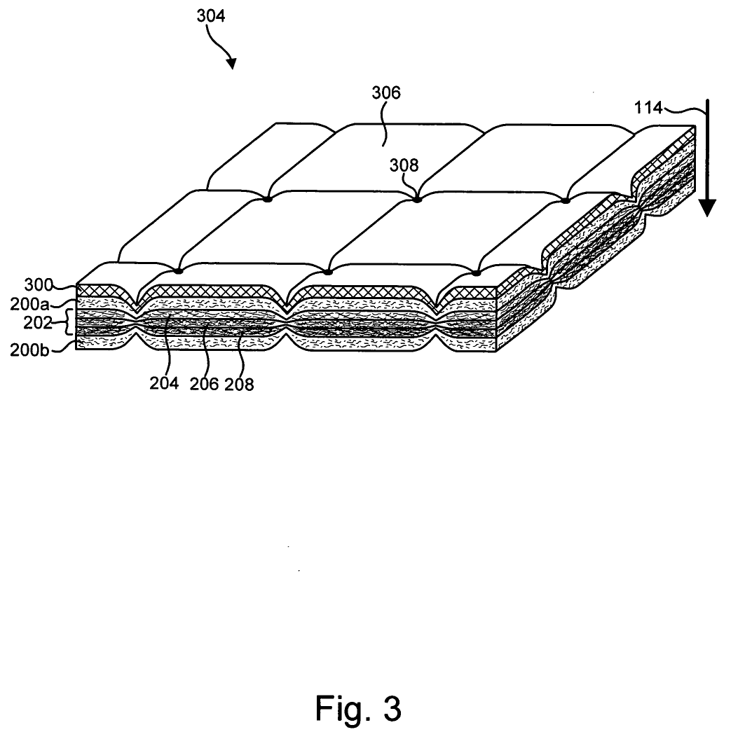

The inlet 102 may be formed to direct the fuel from an exterior fuel source, such as a gas pump, to the fuel tank 100. From the fuel tank 100, fuel may be directed to a fuel pump 106 housed individually or within the fuel sending unit 108 by negative pressure electrically created by the fuel pump 106, or by any other means known to those in the art. The fuel sending unit 108 may be mounted and sealed within the fuel tank 100 to protect sensitive fuel pump 106 components, and may communicate with a supply line 110 adapted to transport the fuel to fuel injectors (not shown) or other target device known to those in the art. Alternatively, the fuel pump 106 may comprise a mechanically operated fuel pump 106 residing outside the fuel tank 100, where the supply line 110 communicates with a carburetor (not shown) or other target device. In any case, a gradient density depth filtration system in accordance with the present invention may intercept the fuel's direction of travel 114 from the fuel tank 100 to the fuel pump 106 to effectively filter particulate matter from the fuel prior to use, as discussed in more detail with reference to FIGS. 2 and 3 below.

Similarly, a conventional cooling system (not shown), may implement the gradient density depth filtration system of the present invention to effectively filter particulate matter from a liquid medium used to dissipate heat from a target device, such as an automobile engine. A typical automobile cooling system includes an engine, a pump, a radiator, and a series of belts, clamps and hoses to connect them together. In operation, the pump drives a liquid medium through hoses proximate the engine to collect heat generated thereby. A liquid medium may comprise, for example, water, a coolant such as ethylene glycol, a combination thereof, or any other liquid medium known to those in the art. Connecting hoses may then direct the liquid medium to the radiator, where heat collected from the engine may be dissipated into the atmosphere. A gradient density depth filtration system in accordance with the present invention may be implemented between the pump and a first hose to filter the liquid medium prior to dissemination over the engine, thereby optimizing the liquid medium's cooling capabilities.

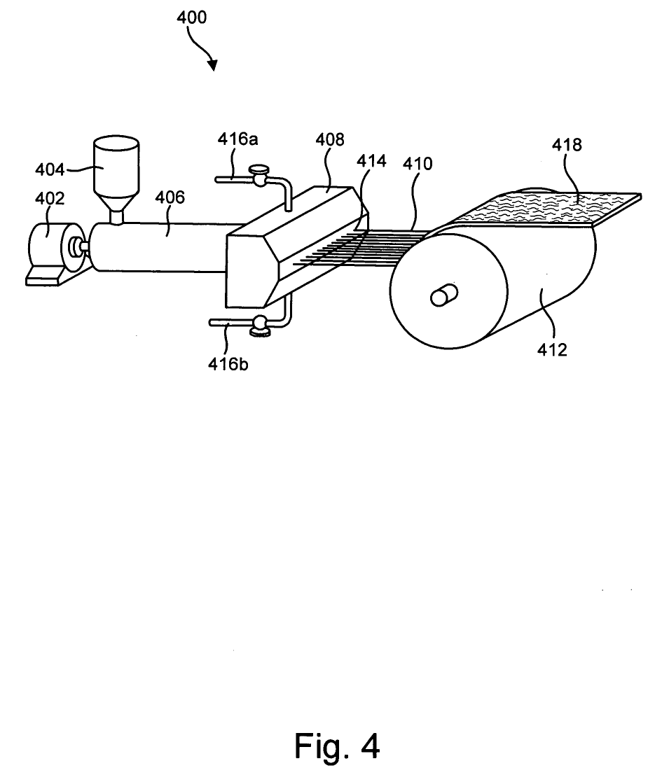

Referring now to FIG. 2, a gradient density depth filtration system in accordance with the present invention may generally comprise a melt-blown filtration assembly 202 having multiple meltblown layers 204, 206, and 208 of varying porosity. Indeed, variation in porosity produces corresponding variation in interstitial or pore size, thus providing varying layer filtration capabilities. This method of relying on porosity or density gradient variation to vary layer filtration capability facilitates an effective depth-media type filter made of acetal and/or another substantially dimensionally stable thermoplastic compatible with various fuels, coolants, and other fluids, as discussed in more detail with reference to FIGS. 4-7 below.

In some embodiments, for example, a first layer 204 of the melt-blown filtration assembly 202 may include a porosity between about 90 and 98% to provide initial small particulate filtration. The first layer 204 may be coupled to a second layer 206 adapted to provide filtration of small particulates of a reduced magnitude. A porosity corresponding to the second layer 206 may range, for example, between about 85 and 97%. Finally, the second layer 206 of the melt-blown filtration assembly 202 may be coupled to a third layer 208 adapted to provide filtration of fine particulates. A porosity corresponding to the third layer 208 may range, for example, between about 80 and 96%. In this manner, the melt-blown filtration assembly 202 of the present invention provides increasingly fine filtration of a fluid having a direction of travel 114 from the first layer 204 to the third layer 208. Of course, one skilled in the art will recognize that the first, second and third layers 204, 206 and 208 of the melt-blown filtration assembly 202 disclosed above are for illustrative purposes only, and that a melt-blown filtration assembly 202 in accordance with the present invention may include any number of layers arranged to provide increasingly fine filtration. Further, in some embodiments, the melt-blown filtration assembly 202 may include a graduated arrangement of melt-blown microfilaments integrated into a unitary whole, such that the melt-blown filtration assembly 202 is substantially devoid of individually identifiable layers.

In some embodiments, the melt-blown filtration assembly 202 may be coupled to at least one general filtration element 200 adapted for relatively coarse filtration, thus further contributing to a graduated filtering effect. In certain embodiments, the melt-blown filtration assembly 202 may be sandwiched between two general filtration elements 200a and 200b to substantially encapsulate the more delicate meltblown layers of the melt-blown filtration assembly 202, thereby protecting the melt-blown filtration assembly 202 as well as contributing to overall filtration.

The general filtration element 200 may include a spun bonded filtration medium, referring to that class of nonwoven materials where newly formed filaments are immediately subjected to cold air to stop their attenuation. The general filtration element 200 may have a porosity more than a porosity corresponding to the first layer 204 of the melt-blown filtration assembly 202, such that the general filtration element 200 provides preliminary filtration of relatively large particulate matter from a fluid. The general filtration element 200 may comprise, for example, spun bonded nylon, polyester, acetal, Teflon®, or other spun bonded filtration medium known to those in the art. The average filament diameter of such a medium may comprise, for example, about 100 μm.

Referring now to FIG. 3, in certain embodiments, a gradient density depth filtration system may further include an outer filtration element 300 coupled to the general filtration element 200 and/or melt-blown filtration assembly 202 to further protect against environmentally imposed stresses, such as mechanical stresses resulting from contact with the tank 100 or other system components, and/or chemical stresses induced by exposure to the fluid. An outer filtration element 300 may include a coarse extruded material such as nylon, polyester, acetal, Teflon®, or other material known to those in the art. The material may be woven to produce a substantially structurally stable mesh. Indeed, as the primary purpose of the outer filtration element 300 is to protect more sensitive components coupled thereto, a porosity corresponding to the outer filtration element 300 may be substantially more than even the general filtration element 200. In some embodiments, for example, an interstitial mesh width may range between about 100 and 1,000 μm. Interstitial size of the outer filtration element 300, however, is not critical, provided that it does not interfere with the structural integrity and durability of the outer filtration element 300.

In further embodiments, a gradient density depth filtration system may include two or more panels 306, each panel 306 comprising a melt-blown filtration assembly 202 substantially sandwiched between two general filtration elements 200. An outer filtration element 300 may be coupled to the most exterior general filtration elements 200, such that the outer filtration element 300 essentially encapsulates every other component of the gradient density depth filtration system. In some embodiments, each panel 306 may be sonically point-bonded to provide distinct filtration regions 306 demonstrating increased structural stability. Alternatively, point bonds 308 may reinforce the gradient density depth filtration system across its entire depth.

Referring now to FIG. 4, melt-blown microfilaments of the melt-blown filtration assembly 202 may be produced according to the following process. A polymer may be formed into pellets to facilitate processing by a melt blowing apparatus 400. The melt blowing apparatus 400 may include a feeder 404 to direct the pellets to an extruder 406 coupled to a die head 408. An attenuation force may be applied at the die head 408 to draw the molten polymer through orifices 414 in the die head 408. As soon as the polymer is extruded through the die head 408, high velocity gas may stream through gas manifolds 416 to attenuate the polymer into microfilaments. As the gas stream containing the microfilaments progresses towards a collector screen 412, ambient air may cool and solidify the microfilaments, which may then collect randomly on the collector screen 412 to form a self-bonded non-woven web 418. In some cases, a vacuum may be applied on an inner surface of the collector screen 412 to enhance application of the microfilaments to the collector screen 412 surface.

The melt blowing process generally demands a polymer that is fluid enough to produce fine microfibers, while viscous enough to provide high fiber strength and prevent excessive fiber bonding. Similarly, it is important that the polymer adequately bond with other fibers upon solidifying, while avoiding coalescence by excess fusion. Thus, the more rapid the crystallization and the higher the melting point of the polymer, the better. While nylon is generally deemed the polymer best suited for this demanding process, nylon is uniquely prone to water absorption, rendering it incompatible with applications used to filter water and/or other liquid mediums containing or producing water. Accordingly, because efficient small particle filtration generally requires melt-blown microfilaments, an alternative polymer is needed from which a melt-blown material may be fabricated.

Particularly, a substantially dimensionally stable thermoplastic such as acetal, polyethylene, polypheylenesulfide, high temperature nylon, or other substantially dimensionally stable thermoplastic known to those in the art may be used to create melt-blown microfilaments suitable for use in the gradient density depth filtration system of the present invention. In some embodiments, the substantially dimensionally stable thermoplastic may further resist chemically induced effects caused by chemical reagents such as neutral oils, grease, petroleum-based fuels, alcohols and other organic solvents including esters, ketones, and aliphatic and aromatic hydrocarbons.

Because such a substantially dimensionally stable thermoplastic may not inherently demonstrate qualities amenable to the melt blowing process, however, operational melt blowing parameters may be adjusted to customize the process to the selected thermoplastic polymer. In one embodiment, for example, acetal resins may be formed into pellets for processing by a melt-blowing apparatus 400. Because acetal, unlike nylon, demonstrates very high loft as well as high viscosity, processing speeds and temperatures may be adjusted to permit proper processing of the acetal pellets to form a non-woven web of melt-blown microfilaments.

Indeed, where nylon is the thermoplastic polymer subjected to the melt blowing process, a temperature of the entire melt blowing apparatus 400 normally ranges between about 215° and 340° C., while a temperature of attenuating gas streamed by the gas manifolds 416 typically reaches around 300° C. The present invention, on the other hand, contemplates maintaining the temperature of the melt blowing apparatus 400 below 230° C., in a range between about 160° and 230° C. Such a reduced temperature permits proper processing of acetal or a like thermoplastic subjected to the melt blowing process. Similarly, in certain embodiments, the temperature of the attenuating gas may be maintained in a range between about 190° and 290° C. While such adjustments to temperature may permit acetal and other such thermoplastic polymers to be melt-blown in accordance with conventional melt blowing practice, adjustments to collector screen 412 speed, attenuating gas speed, and polymer throughput may also be required to result in a non-woven web 418 suitable for filtration. In one embodiment, for example, collector screen 412 speed may be maintained in a range between about 2 and 13 m/min, while attenuating gas flow may range between about 64 and 250 m/sec and polymer throughput may range between about 0.07 and 0.75 g/hole/min.

Despite the efficacy of these adjustments in enabling melt-blown acetal to achieve a sufficient non-woven bond despite its characteristic high loft, the relative viscosity of acetal may nevertheless limit the range of achievable microfilament size. As a result, the gradient filtration assembly 202 of the present invention relies primarily on varying densities of melt-blown microfilaments to produce the graduated filter effect previously discussed, rather than depending on varying sizes of microfilaments to produce varying filtration capabilities.

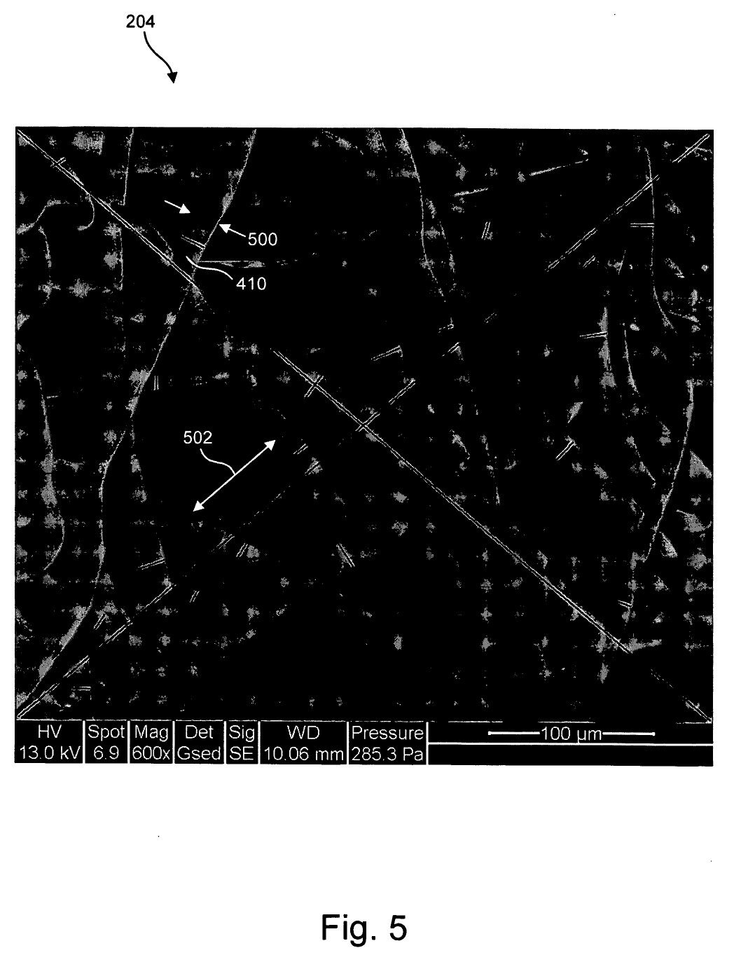

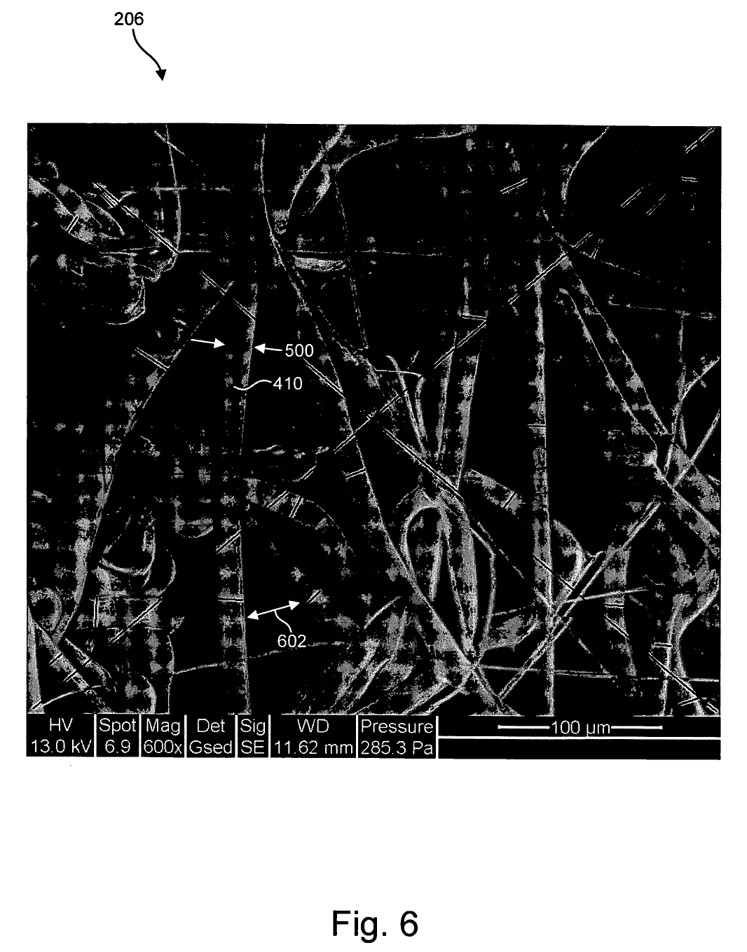

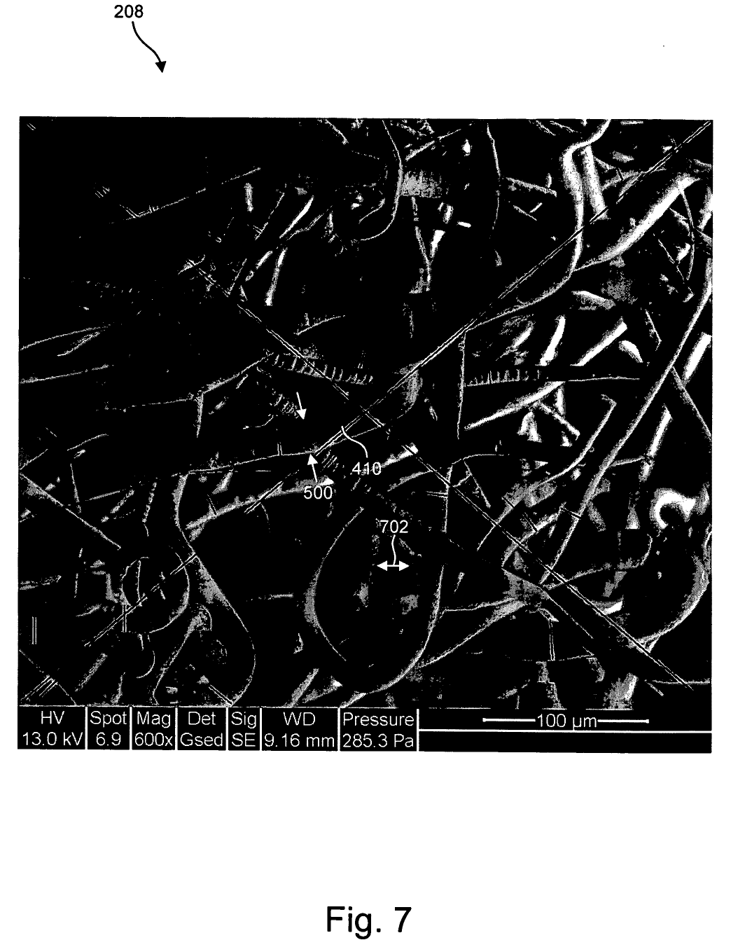

Referring now to FIGS. 5-7, a substantially dimensionally stable thermoplastic such as acetal may be melt-blown to produce microfilaments 410 having a substantially constant diameter size 500. In some embodiments, for example, a diameter 500 of each microfilament may range between about 2.5 and 30 μm. As illustrated by FIG. 5, the first layer 204 of the melt-blown filtration assembly 202 of the present invention may comprise a porosity 502 of about_{—}96% to provide coarse porosity filtration of a fluid. The second layer 206, as shown in FIG. 6, may include microfilaments 410 substantially equal in diameter 500 to those shown in FIG. 5. The second layer 206 microfilaments 410, however, may comprise a porosity 602 of about 94% to provide intermediate porosity filtration of the fluid. Finally, the third layer 208, illustrated by FIG. 7, may comprise microfilaments 410 comparable in diameter 500 to the first and second layers 204 and 206 depicted by FIGS. 5 and 6, although the third layer 208 may demonstrate a porosity 702 of about 92 to provide fine porosity depth filtration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for filtering a fluid, comprising:
a melt-blown filtration assembly to provide increasingly fine filtration of a fluid, the melt-blown filtration assembly comprising varying porosities of melt-blown microfilaments having a substantially constant diameter.

2. The apparatus of claim 1, wherein the melt-blown microfilaments comprise a substantially dimensionally stable thermoplastic.

3. The apparatus of claim 2, wherein the substantially dimensionally stable thermoplastic resists chemically induced effects.

4. The apparatus of claim 2, wherein the substantially dimensionally stable thermoplastic comprises at least one of acetal, polyethylene, polyphenylenesulfide, and high temperature nylon.

5. The apparatus of claim 1, wherein the melt-blown filtration assembly further comprises a plurality of melt-blown layers, each of the plurality of melt-blown layers comprising a unique and substantially constant porosity of the melt-blown microfilaments.

6. The apparatus of claim 5, wherein the porosity corresponding to each of the plurality of melt-blown layers decreases as a distance between the melt-blown layer and a target device decreases.

7. The apparatus of claim 1, further comprising a general filtration element coupled to the melt-blown filtration assembly to provide coarse filtration, the general filtration element comprising a spun bonded filtration media.

8. The apparatus of claim 7, further comprising an outer filtration element substantially adjacent the general filtration element to protect the general filtration element and melt-blown filtration assembly against mechanical stresses.

9. The apparatus of claim 1, wherein the substantially constant diameter of the melt-blown microfilaments comprises a range between about 2 and 5 μm.

10. The apparatus of claim 1, wherein the fluid is selected from the group consisting of a coolant and a fuel.

11. A system for filtering a fluid, comprising:
a tank adapted to store a fluid;
a pump coupled to the tank to pump the fluid to a target device; and
a filter substantially adjacent the pump to filter the fluid prior to reaching the target device, the filter comprising:
a melt-blown filtration assembly to provide increasingly fine filtration of the fluid, the melt-blown filtration assembly comprising varying porosities of melt-blown microfilaments having a substantially constant diameter.

12. The system of claim 11, wherein the melt-blown microfilaments comprise a substantially dimensionally stable thermoplastic.

13. The system of claim 12, wherein the substantially dimensionally stable thermoplastic comprises at least one of acetal, polyethylene, polyphenylenesulfide, and high temperature nylon.

14. The system of claim 11, wherein the melt-blown filtration assembly further comprises a plurality of melt-blown layers, each of the plurality of melt-blown layer comprising a unique and substantially constant porosity of the melt-blown microfilaments.

15. The system of claim 14, wherein the porosity corresponding to each of the plurality of melt-blown layers decreases as a distance between the melt-blown layer and the target device decreases.

16. The system of claim 11, wherein the filter further comprises a general filtration element coupled to the melt-blown filtration assembly, the general filtration element comprising a spun bonded filtration media.

17. The system of claim 16, wherein the filter further comprises an outer filtration element substantially adjacent the general filtration element to protect the general filtration element and melt-blown filtration assembly against mechanical stresses.

18. A method for filtering a fluid, comprising:
melt blowing a substantially dimensionally stable thermoplastic to form melt-blown microfilaments having a substantially constant diameter;
forming the melt-blown microfilaments into a melt-blown layer having a unique and substantially constant porosity;
arranging a plurality of the melt-blown layers according to their relative densities to produce a melt-blown filtration assembly; and
filtering a fluid through the melt-blown filtration assembly to provide increasingly fine filtration of the fluid.

19. The method of claim 18, further comprising selecting the substantially dimensionally stable thermoplastic to include at least one of acetal, polyethylene, polyphenylenesulfide, and high temperature nylon.

20. The method of claim 18, wherein filtering the fluid comprises filtering a fluid selected from the group consisting of a coolant and a fuel.
